(19) United States
(12) Patent Application Publication
(10) Pub. No.: US 2020/0383858 A1
(43) Pub. Date: Dec. 10, 2020

(54) AIRWAY SUPPORT DEVICE

(71) Applicant: Stephen Ray, Elgin, SC (US)

(72) Inventor: Stephen Ray, Elgin, SC (US)

(21) Appl. No.: 16/431,853

(22) Filed: Jun. 5, 2019

(51) Int. Cl. A61G 13/12; A47G 9/10

(52) U.S. Cl. CPC A61G 13/1215; A47G 2009/1018; A47G 9/10; A61G 13/126

(57) ABSTRACT

An airway support device is provided having a head support pillow with a bottom surface and an opposing top surface adapted to contact and support a side of a patient's head. A chin support is adapted to be positioned adjacent to the pillow where the chin support positions and supports a chin of the patient to provide an unobstructed airway.

### TECHNICAL FIELD AND BACKGROUND OF THE INVENTION

This invention relates to an airway support device to maintain a patient's airway in a proper position and prevent airway obstruction during decreased levels of patient consciousness.

Monitored Anesthesia Care (MAC) and deep sedation with intravenous anesthetics are commonly performed techniques for patients undergoing a variety of endoscopy procedures, such as colonoscopy and esophagogastroduodenoscopy (EGD). During such procedures the patient is placed in the left lateral position to aid the conducting of the procedure and to protect the patient from aspiration in the event of vomiting or regurgitation while sedated.

Respiratory depression and airway obstruction may occur as a result of sedation, causing tissues in the pharynx and larynx, including the posterior tongue and the epiglottis, to impede spontaneous ventilation. Techniques for manually opening the airway include head-tilt (chin-lift maneuver) and anterior displacement of the jaw (jaw-thrust maneuver). Both maneuvers provide the align of the axes of the airway, allowing proper ventilation. Because the patient is sedated there will be passive recoil of the head and jaw, so to maintain either of these positions the anesthesia provider must manually support the patient's head for the entirety of the procedure.

Other techniques for alleviating airway obstruction during MAC or deep sedation include insertion of an oropharyngeal airway or a nasopharyngeal airway. An oropharyngeal airway is a rigid curved device that is placed into the mouth and pharynx such that a space is created between the posterior pharynx and the tongue. A nasopharyngeal airway is a soft curved tube that is lubricated and placed into the nose and posterior pharynx such that a space is created by the tube. The oropharyngeal and nasopharyngeal airway devices are invasive and may not be tolerated by the patient. Patients may require excessive amounts of anesthesia to tolerate an invasive airway. Even after insertion of an oropharyngeal or nasopharyngeal airway, the patient often still requires manual positioning by the anesthesia provider to achieve a suitably open airway.

The anesthesia provider is responsible for many tasks during an endoscopy procedure involving MAC or deep sedation, including administration of anesthetic, preparation of subsequent anesthetic, preparation of other medications, monitoring of vital signs and capnography, adjustments in oxygen delivery and oxygen delivery devices, procedural documentation, communication with the procedurist and supporting staff, maintaining the patient's body position, maintaining the patient's head position, and opening the patient's airway. If the anesthesia provider's hands are occupied holding open the patient's airway, the ability to perform other tasks is greatly impaired. Often the anesthesia provider allows periods of airway occlusion in order to use their hands to perform other tasks. Also, the anesthesia provider may experience fatigue from the continuous physical demand of manually maintaining an open airway. In cases of extreme difficulty and fatigue the anesthesia provider may elect to administer a general anesthetic, exposing the patient to additional risks.

### SUMMARY OF THE INVENTION

It is therefore an object of the present invention to provide an airway support device that enables hands-free maintenance of a patient's airway.

It is another object of the present invention to provide an airway support device which is simple to use, easy to clean, and reusable.

These and other objects and advantages of the present invention are achieved in the preferred embodiments set forth below by providing an airway support device having a head support pillow having a bottom surface and an opposing top surface adapted to contact and support a side of a patient's head. A chin support is adapted to be positioned adjacent to the pillow where the chin support positions and supports a chin of the patient to provide an unobstructed airway.

According to another embodiment of the invention, the chin support includes at least one laterally-protruding peg adapted to engage the chin of the patient.

According to another embodiment of the invention, the at least one peg is integral with the chin support.

According to another embodiment of the invention, the chin support is attached to the pillow.

According to another embodiment of the invention, two spaced-apart chin positioning pegs are positioned on the chin support and adapted to engage an underside of the patient's chin proximate to the patient's lower jaw.

According to another embodiment of the invention, the at least one peg has a protective coating.

According to another embodiment of the invention, the at least one peg has a protective end cap.

According to another embodiment of the invention, the pillow is made of foam.

According to another embodiment of the invention, the pillow includes an indentation on a top surface positioned to accommodate an ear of the patient.

According to another embodiment of the invention, the pillow includes a top part which forms the top surface and a bottom part connected to the top part which forms the bottom surface.

According to another embodiment of the invention, the top part is made of a material which is more compressible than the material of the bottom part.

According to another embodiment of the invention, a covering adapted is provided to cover at least the top surface of the pillow.

According to another embodiment of the invention, the chin support is adjustable along a direction perpendicular to the plane of the top surface of the pillow.

According to another embodiment of the invention, the chin support is adjustable along a direction parallel to the plane of the top surface of the pillow.

According to another embodiment of the invention, the at least one peg is adjustable along the length of the peg support in a direction perpendicular to the plane of the top surface of the pillow.

According to another embodiment of the invention, the at least one peg is adjustable along a direction parallel to the plane of the top surface of the pillow.

According to another embodiment of the invention, the pillow is adjustable in height.

According to another embodiment of the invention, the bottom surface of the pillow includes a friction increasing surface.

According to another embodiment of the invention, an airway support device is provided having a head support pillow having a bottom surface and an opposing top surface adapted to contact and support a side of a patient's head. A chin support is adapted to be positioned adjacent to the pillow where the chin support positions and supports the chin of the patient to provide an unobstructed airway. At least one laterally-protruding peg is carried by the chin support and adapted to engage the chin of the patient.

According to another embodiment of the invention, an airway support device is provided having a head support pillow having a bottom surface and an opposing top surface adapted to contact and support a side of a patient's head. A chin support is adapted to be positioned adjacent to the pillow where the chin support positions and supports a chin of the patient to provide an unobstructed airway. At least one laterally-protruding peg is carried by the chin support and adapted to engage the chin of the patient. An indentation in the pillow is positioned to accommodate an ear of the patient.

### BRIEF DESCRIPTION OF THE DRAWING FIGURES

The present invention is best understood when the following detailed description of the invention is read with reference to the accompanying drawings, in which:

FIG. 1 is a perspective view of an airway support device;

FIG. 2 is another perspective view of the airway support device from FIG. 1 from a different angle;

FIG. 3 is a perspective view of the airway support device from FIG. 1 in use;

FIG. 4 is a top view of the airway support device from FIG. 3;

FIG. 5 is a perspective view of an alternative embodiment of an airway support device; and

FIG. 6 is a perspective view of an alternative embodiment of an airway support device.

### DETAILED DESCRIPTION OF THE PREFERRED EMBODIMENT

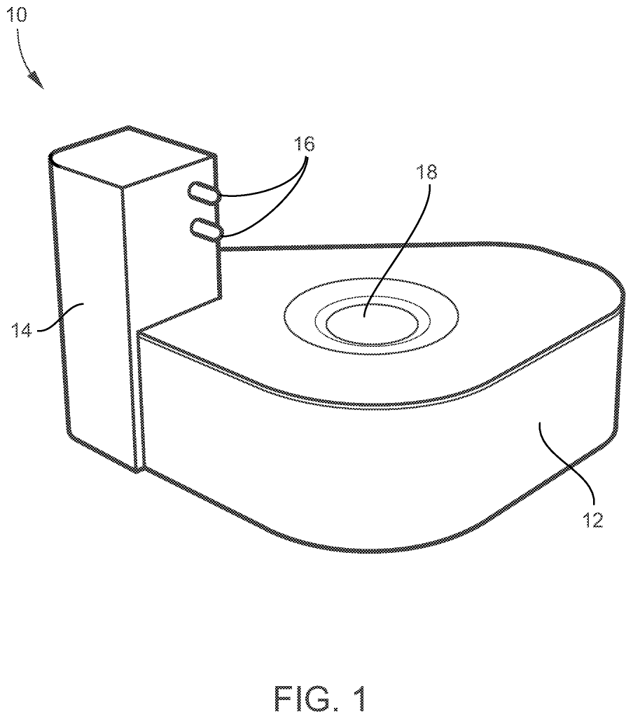

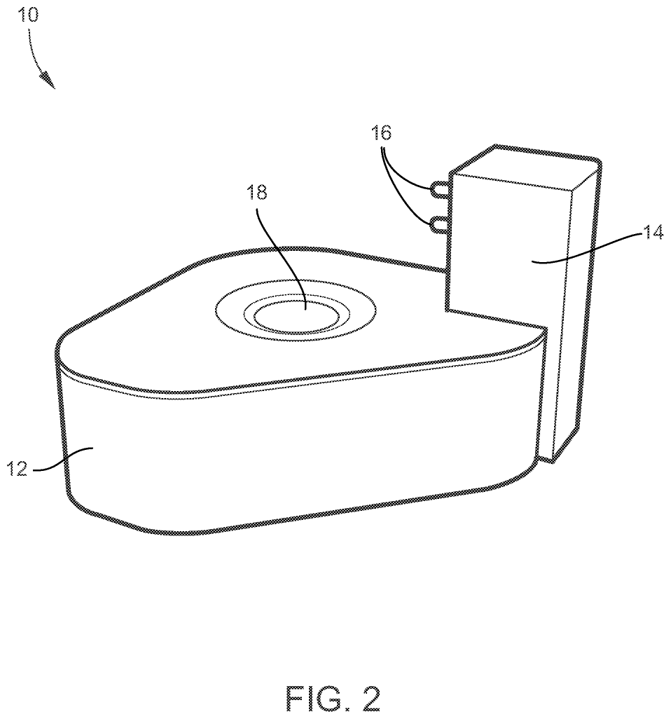

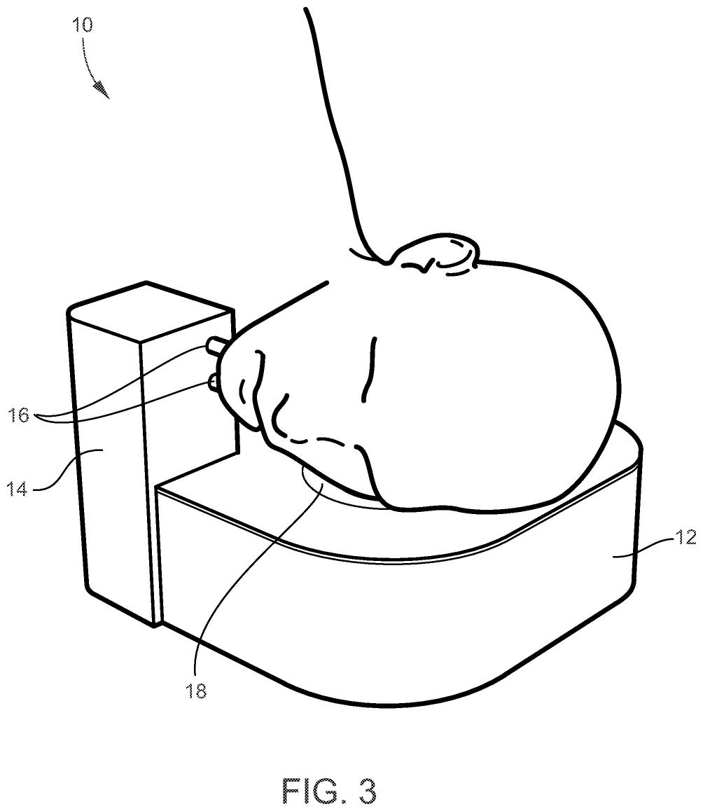

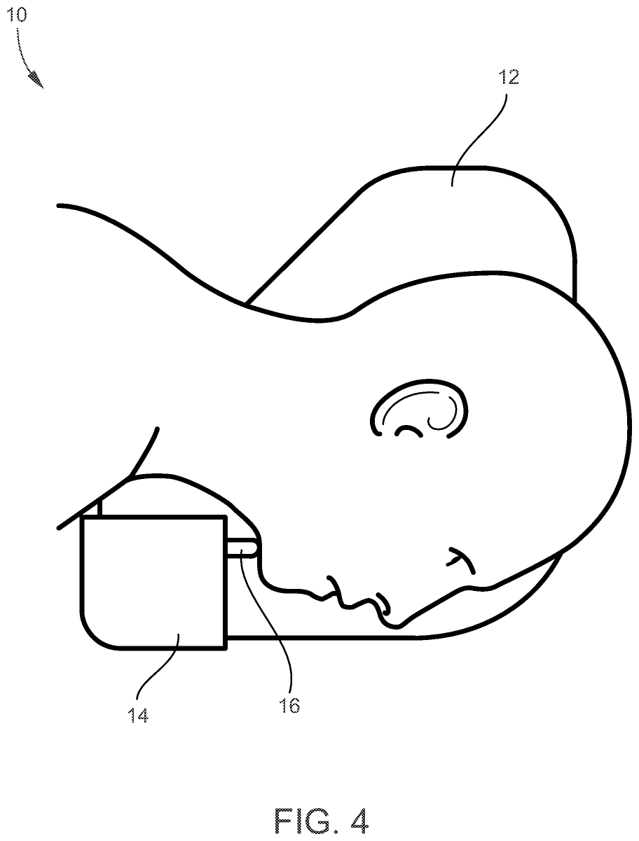

Referring now to the Figures, one embodiment of an airway support device 10 is shown in FIGS. 1-4. The device 10 has a head support pillow 12, a peg support 14, and chin positioning pegs 16. A singular peg 16 is within the scope of this disclosure. Chin positioning does not have to be specifically provided by two laterally extending pegs 16; other embodiments will serve equally well. FIGS. 1 and 2 show only the device 10 while FIGS. 3 and 4 show the patient's head positioned in the device 10. The patient rests a side of the head on the pillow 12 and the pegs 16 provide positioning and support to the bottom chin of the patient such that the patient is in a chin lift position which allows for an unobstructed airway when a patient is in a diminished state of consciousness, for example when a patient is under anesthesia. The device 10 can be configured for either right or left lateral support of the patient's head.

As best seen in FIGS. 1 and 2, the device 10 may include an indentation 18 which provides a cavity for a patient's ear to reside. Depending on the material used for the pillow 12, the indentation 18 may or may not be necessary. Formation of the indentation 18 may be an integral part of the pillow 12 formed during creation of the pillow 12, or formed after the pillow 12 has been formed. The indentation 18 may be made of the same material as the pillow 12, or made of a different material. When the indentation 18 is made of a different material, the indentation 18 may be fitted into an open space of the pillow 12 and attached by friction, adhesives, chemical bonding, various mechanical fasteners, and/or other suitable attachment methods. It is also envisioned that the indentation 18 may be adjustable in height to accommodate patients of different sizes.

The peg support 14 extends from an edge of the pillow 12 and is positioned to be proximate to the patient's neck and chin. In one embodiment the peg support 14 may not be connected to the pillow 12. Positioning the peg support 14 enables the pegs 16 to protrude in a manner such that the pegs 16 make contact with an underside of the patient's lower jaw/chin when the patient's head is positioned on the pillow 12. Placement of the peg support 14 and the pegs 16 provide support and maintain the patient in the chin lift position discussed previously.

The cross-section of the peg support 14 is not limited to the rectangular shape with one rounded corner shown in the Figures, in other embodiments a peg support may have a variety of cross-sections such as round, oval, square, shapes with one or more rounded corners, a cross-section that is not uniform, a bar, and/or any other suitable cross-section. Proportions between the cross-sectional area of the peg support 14 and the pillow 12 are not limited to what is shown in the figures. In one embodiment the peg support 14 may be only a rod having a small diameter relative to the cross-sectional area of the peg support 14 shown in the figures. The peg support 14 may be made of any suitable material such as, but not limited to, plastic, wood, metal, rubber, and/or any other suitable material.

FIGS. 1 and 3 best show the pegs 16 while not in use (FIG. 1) and while in use (FIG. 3). The pegs 16 are made of a rigid material such as wood, metal, plastic, gel-like materials, and/or other suitable materials. It is envisioned that the pegs 16 may be coated with a secondary material such as, but not limited to, a gel-like material. In one embodiment the pegs 16 are made of plastic and coated in a material such as silicone, rubber, or some type of viscoelastic polymer material. The pegs 16 may also include an end cap that can be removed for cleaning or replacement, shape of the pegs 16 is shown as cylinders or dowels having a small radius as compared to length. Pegs of other embodiments may also have a larger end surface for making contact with a patent in comparison to the cross-section area of the rest of the pegs which extend from the end surface to the peg support 14. In other embodiments, pegs may be an integral part of a peg support.

The peg support 14 and the pegs 16 may be adjustable for use on different patients. The peg support 14 may be adjustable in a horizontal direction or a vertical direction. The peg 16 may be adjustable along the length of the peg support 14 or adjustable perpendicular to the peg support 14. Adjustability may be achieved by any suitable methods.

The pillow 12 may be made of a rigid material, memory foam, a gel-like material, silicone, plastic, an elastomer, rubber, a viscoelastic polymer, and/or some other suitable material which provides comfort and support for the patient. The material can be formed from larger blocks of material, can be formed within a mold, some combination of the two and/or any other suitable method. The entire pillow 12 may be made of the same material, or the pillow 12 may comprise two or more parts of different material. In one embodiment the pillow 12 is made of plastic with a silicone covering having sufficient thickness at the top for supporting the patients head.

The shape of the pillow 12 is shown as relatively triangular however it is envisioned that the pillow 12 can be any shape. Ideally the shape is optimally designed to accommodate the patient's head but other considerations such as the specific application of the device 10, manufacturing cost and capabilities, storage requirements, and/or other considerations may influence the shape selected.

The bottom of the device 10, which makes contact with a surface such as a stretcher or hospital bed, may include some type of friction-increasing feature. The friction-increasing feature may be adhesives (removable and permanent), hook-and-loop fasteners, other fasteners, a rough surface, or other suitable friction increasing methods. It is also envisioned that other sides of the pillow and/or peg support 14 may include friction-increasing features.

Optionally, the pillow 12 may have a covering that is removable for sanitation purposes. The covering may be fitted or adapted to lie on top of the pillow 12. The covering may be a paper or cloth product that can be disposed of, a cloth material that can be laundered, and/or any other suitable material. The pillow 12 may have a standard height for different patients, and/or the pillow 12 may be adjustable in height.

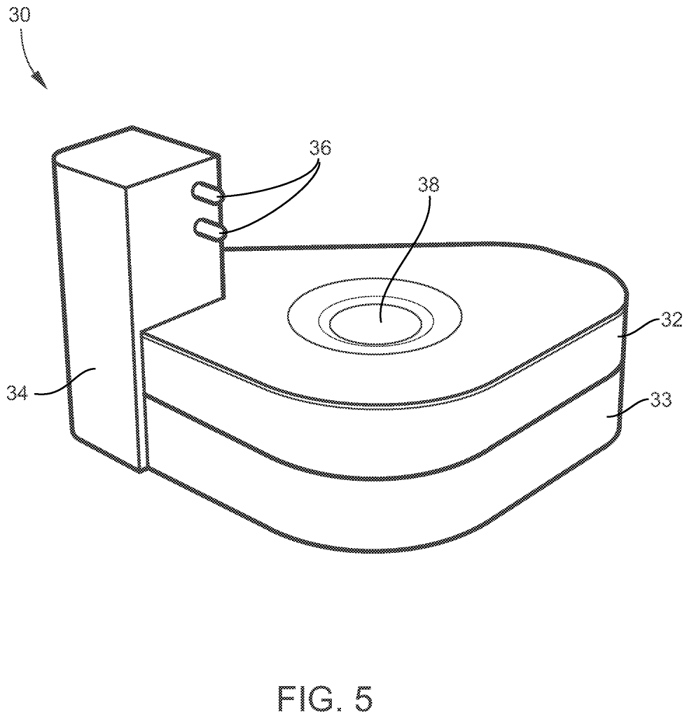

FIG. 5 shows a two part configuration of an airway support device 30. The two part device 30 has a top, relatively softer, part 32 which makes contact with the patient's head and a bottom, relatively harder, part 33 connected to the top part 32. Similar to the embodiment of FIGS. 1-4, the FIG. 5 device 30 has a peg support 34, a peg 36, and an indentation 38. This configuration enables the two part device 30 to reach the desired height, utilize materials which have the potential to be relatively inexpensive on the bottom 33 as compared to the top 32 (or vice versa), as well as other benefits. In the two part embodiment the top part 32 may be detachable from the bottom part 33. The detachability enables the pillow to be cleaned or replaced and may also enable the attachment of different top part 32 with varying heights in order to accommodate different patients.

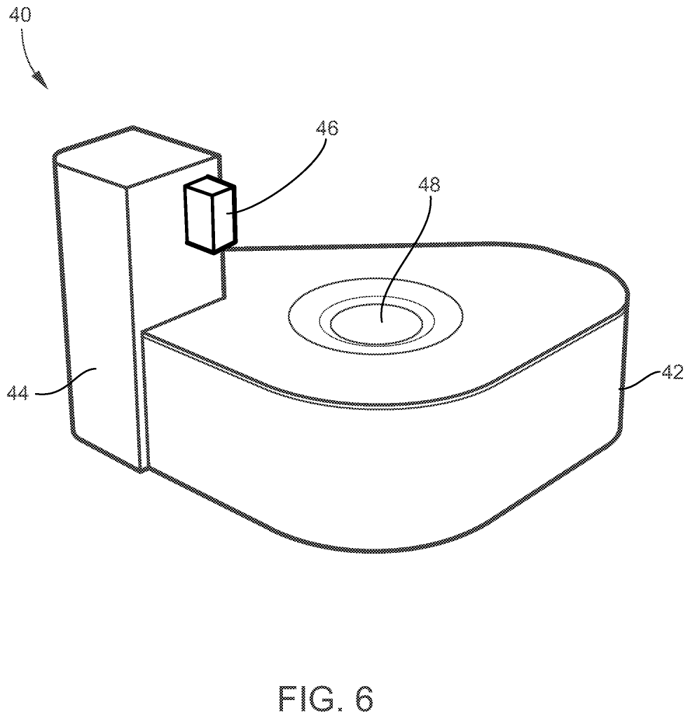

FIG. 6 shows an airway support device 40 with a peg 46 which is integral to, and a protrusion from, a peg support 44. Similar to the embodiment of FIGS. 1-4, the FIG. 6 device 40 has a pillow 42 and an indentation 48. The peg 46 can have a flat surface upon which the patient rests the chin, or can have a concave surface into which the patient places the chin.

The pegs 16, 46 may have a variety of shapes and configurations. Each peg may form a Y for supporting the sides of the patients jaw. The Y may be adjustable to suit the patient. Two pegs may be connected to form a flat or concave surface for the patient to place the chin or may have a flexible membrane suspended between the pegs. These connections may be adjustable, for example with a hinge, to accommodate different patients.

An airway support device according to the invention has been described with reference to specific embodiments and examples. Various details of the invention may be changed without departing from the scope of the invention. Furthermore, the foregoing description of the preferred embodiments of the invention and best mode for practicing the invention are provided for the purpose of illustration only and not for the purpose of limitation, the invention being defined by the claims.

What is claimed is:

1. An airway support device, comprising:
a. a head support pillow having a bottom surface and an opposing top surface adapted to contact and support a side of a patient's head; and
b. a chin support adapted to be positioned adjacent to the pillow where the chin support positions and supports a chin of the patient to provide an unobstructed airway.

2. An airway support device according to claim 1, wherein the chin support includes at least one laterally-protruding peg adapted to engage the chin of the patient.

3. An airway support device according to claim 2, wherein the at least one peg is integral with the chin support.

4. An airway support device according to claim 1, wherein the chin support is attached to the pillow.

5. An airway support device according to claim 1, wherein two spaced-apart chin positioning pegs are positioned on the chin support and adapted to engage an underside of the patient's chin proximate to the patient's lower jaw.

6. An airway support device according to claim 2, wherein the at least one peg has a protective coating.

7. An airway support device according to claim 2, wherein the at least one peg has a protective end cap.

8. An airway support device according to claim 1, wherein the pillow is made of foam.

9. An airway support device according to claim 1, wherein the pillow includes an indentation on a top surface positioned to accommodate an ear of the patient.

10. An airway support device according to claim 1, wherein the pillow includes a top part which forms the top surface and a bottom part connected to the top part which forms the bottom surface.

11. An airway support device according to claim 10, wherein the top part is made of a material which is more compressible than the material of the bottom part.

12. An airway support device according to claim 1, further comprising a covering adapted to cover at least the top surface of the pillow.

13. An airway support device according to claim 1, wherein the chin support is adjustable along a direction perpendicular to the plane of the top surface of the pillow.

14. An airway support device according to claim 1, wherein the chin support is adjustable along a direction parallel to the plane of the top surface of the pillow.

15. An airway support device according to claim 2, wherein the at least one peg is adjustable along the length of the peg support in a direction perpendicular to the plane of the top surface of the pillow.

16. An airway support device according to claim 2, wherein the at least one peg is adjustable along a direction parallel to the plane of the top surface of the pillow.

17. An airway support device according to claim 1, wherein the pillow is adjustable in height.

18. An airway support device according to claim 1, wherein the bottom surface of the pillow includes a friction increasing surface.

19. An airway support device, comprising:
a. a head support pillow having a bottom surface and an opposing top surface adapted to contact and support a side of a patient's head;
b. a chin support adapted to be positioned adjacent to the pillow where the chin support positions and supports the chin of the patient to provide an unobstructed airway; and
c. at least one laterally-protruding peg carried by the chin support and adapted to engage the chin of the patient.

20. An airway support device, comprising:
a. a head support pillow having a bottom surface and an opposing top surface adapted to contact and support a side of a patient's head;
b. a chin support adapted to be positioned adjacent to the pillow where the chin support positions and supports a chin of the patient to provide an unobstructed airway;
c. at least one laterally-protruding peg carried by the chin support and adapted to engage the chin of the patient; and
d. an indentation in the pillow positioned to accommodate an ear of the patient.
